(19) United States
(12) Patent Application Publication
(10) Pub. No.: US 2011/0310075 A1
(43) Pub. Date: Dec. 22, 2011

(54) LIQUID CRYSTAL DISPLAY AND DRIVING METHOD THEREOF

(75) Inventors: Joon-Chul GOH, Hwaseong-si (KR); Chong-Chul CHAI, Seoul (KR); Seong-Young LEE, Anyang-si (KR); Kwang-Chul JUNG, Seongnam-si (KR); Young-Soo YOON, Anyang-si (KR)

(73) Assignee: SAMSUNG ELECTRONICS CO., LTD., Suwon-si (KR)

(21) Appl. No.: 12/965,426

(22) Filed: Dec. 10, 2010

(30) Foreign Application Priority Data
Jun. 16, 2010 (KR) 10-2010-0056981

(51) Int. Cl. G09G 5/00; G09G 3/36

(52) U.S. Cl. 345/211; 345/87

(57) ABSTRACT

A liquid crystal display includes a gate line; a data line intersecting and insulated from the gate line; a common voltage line separated from the gate line and the data line to transfer a predetermined voltage; a first switching element connected to the gate line and the data line; a second switching element connected to the gate line and the data line; a first liquid crystal capacitor connected to the first switching element; a second liquid crystal capacitor connected to the second switching element; a third switching element that includes an input terminal connected to the second switching element, a floated control terminal, and an output terminal; and a third capacitor connected to the third switching element and the common voltage line.

### CROSS REFERENCE TO RELATED APPLICATION

This application claims priority from and the benefit of Korean Patent Application No. 10-2010-0056981, filed on Jun. 16, 2010, which is hereby incorporated by reference for all purposes as if fully set forth herein.

### BACKGROUND OF THE INVENTION

1. Field of the Invention

Exemplary embodiments of the present invention relate to a liquid crystal display and a driving method thereof.

2. Discussion of the Background

A liquid crystal display, which is one of the most widely used flat panel displays, includes field-generating electrodes such as a pixel electrode and a common electrode and a liquid crystal layer. The liquid crystal display generates an electric field in the liquid crystal layer by applying voltages to the field-generating electrodes. The electric field determines a direction, i.e., inclinations, of liquid crystal molecules of the liquid crystal layer. The orientation of the liquid crystal molecules controls the polarization of incident light, thus affecting the transmission of the incident light through the display to display images.

Among the liquid crystal displays, a vertically aligned mode liquid crystal display that aligns a major axis of the liquid crystal molecule to be vertical to the upper and lower display plates in a state where the electric field is not applied exhibits a large contrast and easily implements a wide reference viewing angle. Due to these qualities, vertically aligned mode liquid crystal displays have received considerable attention.

On the other hand, the vertically aligned mode liquid crystal display may have a diminished side visibility compared with its front visibility. To solve this problem, a method that divides one pixel into two subpixels and makes the voltage of the two subpixels different may be useful.

The above information disclosed in this Background section is only for enhancement of understanding of the background of the invention, and, therefore, it may contain information that does not form the prior.

### SUMMARY OF THE INVENTION

Exemplary embodiments of the present invention provide a liquid crystal display with an enhanced side visibility.

Additional features of the invention will be set forth in the description that follows, and in part will be apparent from the description, or may be learned by practice of the invention.

An exemplary embodiment of the present invention discloses a liquid crystal display that comprises a gate line; a data line intersecting and insulated from the gate line to supply a data voltage; a common voltage line separated from the gate line and the data line; a first switching element connected to the gate line and the data line; a second switching element connected to the gate line and the data line; a first capacitor connected to the first switching element; a second capacitor connected to the second switching element; a third switching element comprising an input terminal connected to the second switching element, a control terminal, and an output terminal; and a third capacitor connected to the third switching element and the common voltage line.

An exemplary embodiment of the present invention also discloses a liquid crystal display that comprises a first substrate and a second substrate facing each other; a gate line, a data line to supply data voltage, and a common voltage line disposed on the first substrate; a first switching element connected to the gate line and the data line; a second switching element connected to the gate line and the data line; a first subpixel electrode connected to the first switching element; a second subpixel electrode connected to the second switching element; a third switching element comprising an input terminal connected to the second switching element, a control terminal, and an output terminal facing the input terminal; and a third capacitor comprising the output terminal of the third switching element and a portion of the common voltage line as two terminals.

An exemplary embodiment of the present invention additionally discloses a driving method of a liquid crystal display comprising a gate line; a data line intersecting and insulated from the gate line; a common voltage line separated from the gate line and the data line; a first switching element connected to the gate line and the data line; a second switching element connected to the gate line and the data line; a first capacitor connected to the first switching element; a second capacitor connected to the second switching element; a third switching element comprising an input terminal connected to the second switching element, a control terminal, and an output terminal; and a third capacitor connected to the third switching element and the common voltage line. The driving method comprises applying data voltage to the data line; charging the first capacitor and the second capacitor with a first voltage by applying a gate-on voltage to the gate line; and changing a charging voltage of the second capacitor through the third switching element.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of a liquid crystal display according to an exemplary embodiment of the present invention.

FIG. 2 is an equivalent circuit diagram for one pixel of a liquid crystal display according to an exemplary embodiment of the present invention.

FIG. 3 is a layout view of one pixel of the liquid crystal display according to an exemplary embodiment of the present invention.

FIG. 4 is a cross-sectional view taken along line IV-IV of the liquid crystal display of FIG. 3.

FIG. 5 is a layout view of one pixel of a liquid crystal display according to another exemplary embodiment of the present invention.

FIG. 6 is a diagram showing changes in voltages during a frame for three terminals N1, N2, and N3 of the liquid crystal display shown in FIG. 2, FIG. 3, FIG. 4, and FIG. 5.

FIG. 7 is a diagram showing portion “P” of FIG. 6 and a gate signal.

FIG. 8 is a diagram showing portion “N” of FIG. 6 and the gate signal.

### DETAILED DESCRIPTION OF THE ILLUSTRATED EMBODIMENTS

The invention is described more fully hereinafter with reference to the accompanying drawings in which embodiments of the invention are shown. This invention may, however, be embodied in many different forms and should not be construed as limited to the embodiments set forth herein. Rather, these embodiments are provided so that this disclosure is thorough and will fully convey the scope of the invention to those skilled in the art. In the drawings, the size and relative sizes of layers and regions may be exaggerated for clarity Like reference numerals in the drawings denote like elements.

It will be understood that when an element or layer is referred to as being “on,” “connected to,” or “coupled to” another element or layer, it can be directly on, directly connected to, directly coupled to the other element or layer, or intervening elements or layers may be present. In contrast, when an element is referred to as being “directly on,” “directly connected to,” or “directly coupled to” another element or layer, there are no intervening elements or layers present.

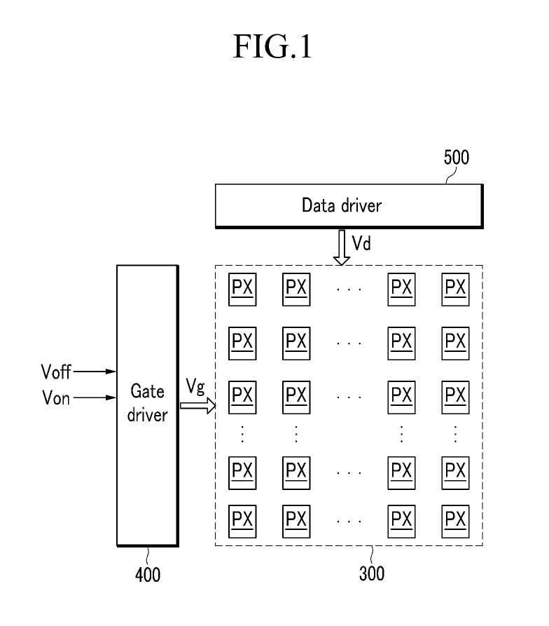

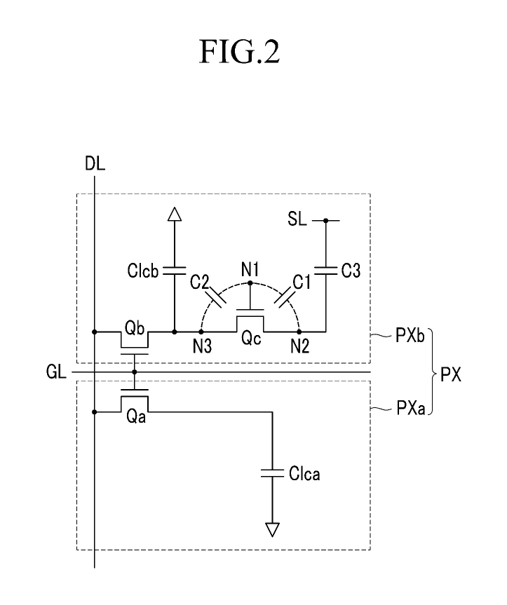

First, a liquid crystal display will be described with reference to FIG. 1 and FIG. 2.

FIG. 1 is a block diagram of a liquid crystal display according to an exemplary embodiment of the present invention, and FIG. 2 is an equivalent circuit diagram of one pixel of the liquid crystal display according to an exemplary embodiment of the present invention.

Referring to FIG. 1, the liquid crystal display according to an exemplary embodiment of the present invention includes a liquid crystal panel assembly 300, a gate driver 400, and a data driver 500.

Referring to FIG. 1 and FIG. 2, the liquid crystal panel assembly 300 includes a plurality of signal lines GL, DL, and SL and a plurality of pixels PX connected to the signal lines GL, DL, and SL and arranged in an approximate matrix format.

The signal lines GL, DL, and SL include a plurality of gate lines GL that transfer a gate signal (hereinafter, referred to as a “scanning signal”), a plurality of data lines DL that transfers data voltage, and a common voltage line SL that transfers a voltage such as a common voltage. The gate lines GL and the common voltage line SL may each extend in an approximate row direction and may be approximately parallel with each other, and the data lines DL may extend in an approximate column direction and may be approximately parallel with each other.

Pixels PX include a first subpixel PXa and a second subpixel PXb. The first subpixel PXa includes a first liquid crystal capacitor Clca and a first switching element Qa, and the second subpixel PXb includes a second liquid crystal capacitor Clcb, a second switching element Qb, a third switching element Qc, and a third capacitor C3.

The first, second, and third switching elements Qa, Qb, and Qc may be a three-terminal element, e.g., a thin film transistor.

A control terminal of the first switching element Qa is connected to the gate line GL. An input terminal thereof is connected to the data line DL, and an output terminal thereof is connected to the first liquid crystal capacitor Clca. A control terminal of the second switching element Qb is connected to the gate line GL. An input terminal thereof is connected to the data line DL, and an output terminal thereof is connected to the second liquid crystal capacitor Clcb.

The first liquid crystal capacitor Clca and the second liquid crystal capacitor Clcb both have two electrodes, for example, the subpixel electrode and the opposed electrode (not shown), and the liquid crystal layer (not shown) between the two electrodes as a dielectric material.

The control terminal N1 of the third switching element Qc is floated. The input terminal N3 thereof is connected to the second switching element Qb and the second liquid crystal capacitor Clcb, and the output terminal N2 thereof is connected to the third capacitor C3. As shown in FIG. 2, the control terminal N1 and the output terminal N2 of the third switch element Qc form the first capacitor C1, and the control terminal N1 and the input terminal N3 of the third switching element Qc form the second capacitor C2.

The two terminals of the third capacitor C3 are connected between the output terminal of the third switching element Qc and the common voltage line SL. The third capacitor C3 may be formed so that the output terminal of the third switching element Qc and a portion of the common voltage line SL overlap with an interposing insulator.

In addition, a sustain capacitor (not shown) performing an auxiliary function of the first and second liquid crystal capacitors Clca and Clcb may also be provided.

To implement a color display with the above features, the pixel PX may display one of the primary colors (spatial division), or the pixels PX may alternately display the primary colors over time (temporal division) so that the desired colors may be displayed through the spatial and temporal sum of the primary colors. Examples of the primary colors include red, green, and blue. As an example of the spatial division, pixels PX may include a color filter (not shown) that represents one primary color.

The liquid crystal panel assembly 300 may include a polarizer (not shown).

Referring again to FIG. 1 and FIG. 2, the data driver 500 is connected to the data line DL of the liquid crystal panel assembly 300 and applies a data voltage Vd to the data line DL. The gate driver 400 is connected to the gate line GL of the liquid crystal panel assembly 300 and applies a gate signal Vg to the gate line GL. The gate signal Vg may be a combination of a gate-on voltage Von that may turn-on the first and second switching elements Qa and Qb and a gate-off voltage Voff that may turn-off the first and second switching elements Qa and Qb.

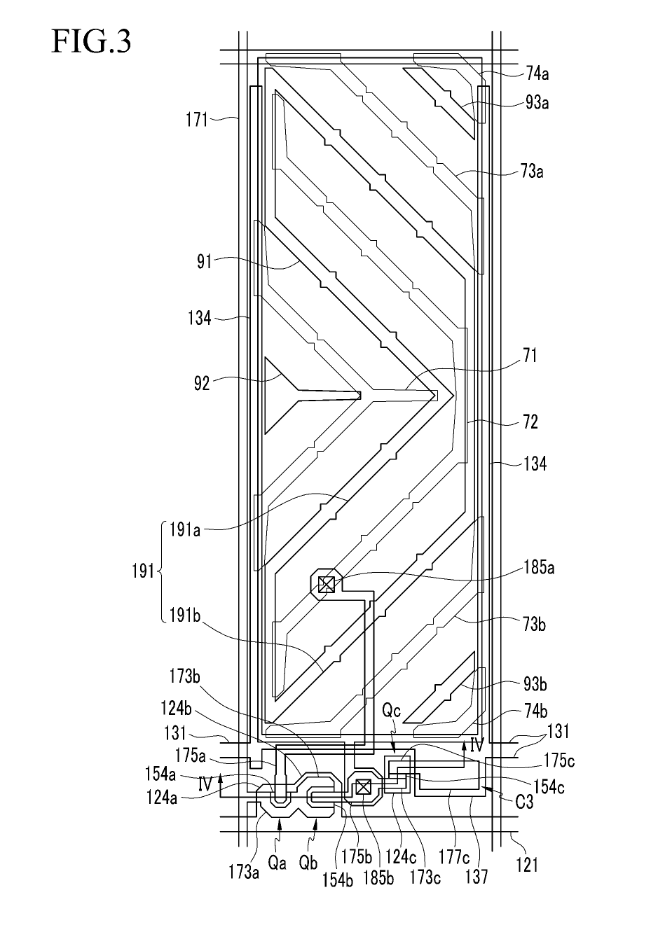

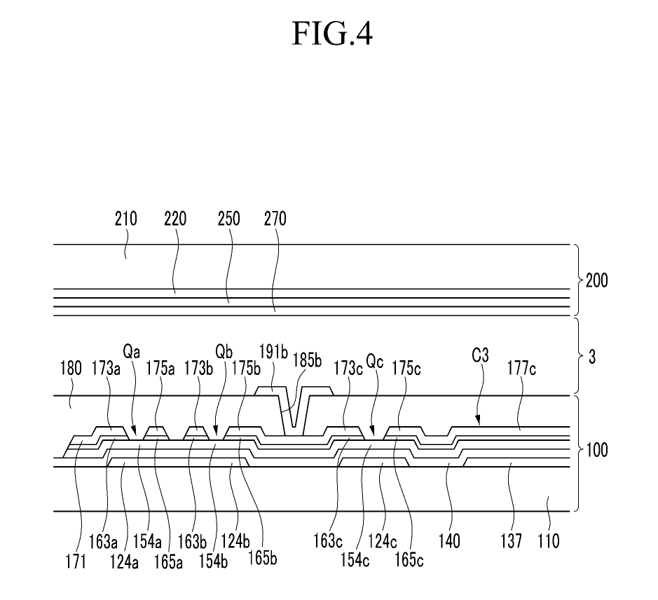

An example of the liquid crystal display shown in FIG. 1 and FIG. 2 is further described with reference to FIG. 3 and FIG. 4.

FIG. 3 is a layout view of one pixel of the liquid crystal display according to an exemplary embodiment of the present invention, and FIG. 4 is a cross-sectional view taken along line IV-IV the liquid crystal display of FIG. 3.

The liquid crystal display according to an exemplary embodiment of the present invention includes a lower panel 100 and an upper panel 200 that are opposite to each other with a liquid crystal layer 3 interposed between them.

First, the lower panel 100 is described.

A plurality of gate conductors including a plurality of gate lines 121, a third gate electrode 124c, and a plurality of common voltage lines 131 are formed on an insulating substrate 110.

The gate line 121 mainly extends in a horizontal direction and transfers the gate signal. The gate line 121 includes a first gate electrode 124a and a second gate electrode 124b that protrude upwardly from the gate line 121. The first gate electrode 124a and the second gate electrode 124b may be connected to each other. The third gate electrode 124c, which is electrically floated, is an island shape.

The common voltage line 131 mainly extends in a horizontal direction and transfers voltage such as a common voltage Vcom. The common voltage line 131 includes a sustain electrode 137 that extends downward from the common voltage line 131 and a pair of vertical portions 134 that extend upward and are approximately perpendicular to the gate line 121.

The gate insulating layer 140 is formed on the gate conductors.

A plurality of semiconductor stripes (not shown) made of, e.g., amorphous silicon or crystalline silicon is formed on the gate insulating layer 140. The semiconductor stripe mainly extends in a vertical direction and includes first and second semiconductors 154a and 154b that extend to face the first and second gate electrodes 124a and 124b and are connected to each other and a third semiconductor 154c that extends from the second semiconductor 154b and is positioned on the third gate electrode 124c

A pair of ohmic contacts 163a and 165a is positioned on the first semiconductor 154a, and a pair of ohmic contacts 163b and 165b is positioned on the second semiconductor 154b. In addition, a pair of ohmic contacts 163c and 165c is positioned on the third semiconductor 154c. The ohmic contact 163a may be connected to the ohmic contact stripe (not shown) positioned on the semiconductor stripe. The ohmic contacts 165a and 163b may be connected to each other, and the ohmic contacts 165b and 163c may be connected to each other.

The ohmic contacts 163a, 165a, 163b, 165b, 163c, and 165c may be made of materials such as n+ hydrogenated amorphous silicon that may be doped with an n-type impurity such as phosphorus at a high concentration or a silicon material.

The data conductor including a plurality of data lines 171, a plurality of first drain electrodes 175a, a plurality of second drain electrodes 175b, and a plurality of third drain electrodes 175c is formed on the ohmic contacts 163a, 165a, 163b, 165b, 163c, and 165c and the gate insulating layer 140.

The data line 171 transfers the data signal and mainly extends in a vertical direction to intersect with the gate line 121 and the common voltage line 131. The data line 171 includes the first source electrode 173a and the second source electrode 173b that extend to the first gate electrode 124a and the second gate electrode 124b and may be connected to each other.

The first drain electrode 175a, the second drain electrode 175b, and the third drain electrode 175c include a bar-type end with its other end being relatively wide. The bar type ends of the first drain electrode 175a and the second drain electrode 175b are partially surrounded with the first source electrode 173a and the second source electrode 173b, respectively. The end having the wide area of the second drain electrode 175b again extends to form the third source electrode 173c that has a bar-type end. The third source electrode 173c faces the third drain electrode 175c. The end 177c of the third drain electrode 175c with a wide end forms the third capacitor C3 by overlapping with the sustain electrode 137 of the common voltage line 131.

The first/second/third gate electrodes 124a/124b/124c, the first/second/third source electrodes 173a/173b/173c, and the first/second/third drain electrodes 175a/175b/175c form the first/second/third thin film transistors (TFT) Qa/Qb/Qc. The first/second/third semiconductors 154a/154b/154c serve, in part, as the channel regions of the respective TFTs between the source electrodes 173a/173b/173c and the drain electrode 175a/175b/175c.

The semiconductor stripe including the first, second, and third semiconductors 154a, 154b, and 154c may have substantially the same planar shape as the data conductor and the ohmic contacts 163a, 165a, 163b, 165b, 163c, and 165c except for the channel region between the first, second, and third source electrodes 173a, 173b, and 173c and the first, second, and third drain electrodes 175a, 175b, and 175c.

A passivation layer 180 that may be made of, e.g., an inorganic insulating material such as silicon nitride or silicon oxide or an organic insulating material is formed on the portions of the data conductor and the exposed first, second, and third semiconductors 154a, 154b, and 154c. However, the passivation layer 180 may have a double layer structure made of the organic insulating material and the inorganic insulating material. The passivation layer 180 is formed with a first contact hole 185a exposing the wider end of the first drain electrode 175a and a second contact hole 185b exposing the wider end of the second drain electrode 175b.

A plurality of pixel electrodes 191 are formed on the passivation layer 180 and may be made of a transparent conductive material such as ITO (indium tin oxide) or IZO (indium zinc oxide) or reflective metals such as aluminum, silver, and chromium or an alloy thereof. The pixel electrode 191 includes a first subpixel electrode 191a and a second subpixel electrode 191b. The pixel electrode 191 may have a quadrangular shape. The first subpixel electrode 191a is surrounded by the second subpixel electrode 191b with the gap 91 therebetween.

The first subpixel electrode 191a includes a lower portion and an upper portion that obliquely extend in opposite directions with respect to the gate line 121.

The second subpixel electrode 191b surrounds the two obliquely extending portions of the first subpixel electrode 191a and includes a funnel-shaped triangular cutout 92, and the upper portion and the lower portion thereof positioned near the upper and lower portions of the two obliquely extending portions of the first subpixel electrode 191a include cutout portions 93a and 93b. The cutout portion 92 includes two oblique sides that extend in parallel with the oblique side of the gap 91 and two horizontal sides that connect to the two oblique sides and extend in a horizontal direction. The cutout portions 93a and 93b are arranged on the outer oblique side of the gap 91 to face each other.

The oblique sides of the gap 91, the oblique sides of the cutout portion 92, and the cutout portions 93a and 93b may form an angle of about 45° or 135° with respect to the gate line 121.

The area of the second subpixel electrode 191b may be larger than the area of the first subpixel electrode 191a.

The first subpixel electrode 191a is supplied with the data voltage from the first drain electrode 175a through the first contact hole 185a, and the second subpixel electrode 191b is supplied with the data voltage from the second drain electrode 175b through the second contact hole 185b. In this case, the first subpixel electrode 191a and the second subpixel electrode 191b may receive the same data voltages, which are supplied from the first and second switching elements Qa and Qb, respectively.

An alignment layer (not shown) may be formed on the pixel electrode 191.

Next, an upper panel 200 will be described.

A light blocking member 220 is formed on an insulation substrate 210. The light blocking member 220 blocks the light leakage between the pixel electrodes 191 and may include an opening (not shown) defining an opening region facing the pixel electrode 191.

A plurality of color filters (not shown) may be formed on the substrate 210 and the light blocking member 220. Most of the color filters may exist in a region surrounded by the light blocking member 220 and may extend length-wise along the pixel electrode 191 column. Each color filter may represent one of the primary colors such as red, green, and blue.

At least one of the light blocking member 220 and the color filter may be positioned on the lower panel 100.

An overcoat 250 is formed on the color filter and the light blocking member 220. However, the overcoat 250 may be omitted.

An opposed electrode 270 is formed on the overcoat 250 to face the pixel electrode 191 and may be supplied with the common voltage Vcom. The opposed electrode 270 may be formed to face the plurality of pixel electrodes 191, for example, all of the pixel electrodes 191. The opposed electrode 270 includes the plural pairs of cutout portions 71, 72, 73a, 73b, 74a, and 74b that have oblique sides matching the shape of the gap 91 of the pixel electrodes 191, the oblique side of the cutout portion 92, and the oblique portion that is substantially parallel with the cutout portions 93a and 93b. Cutout portions 71, 72, 73a, 73b, 74a, and 74b further include a longitudinal portion that extends in a vertical direction or in a horizontal direction from the end of the oblique portion. The cutout portion 71 further includes a horizontal portion that extends in a horizontal direction at a place where the two oblique portions intersect with each other.

An alignment layer (not shown) may be applied to the opposed electrode 270.

The alignment layers on the lower panel 100 and the upper panel 200 may be a vertical alignment layer.

The liquid crystal layer 3 interposed between the lower panel 100 and the upper panel 200 may include liquid crystal molecules having dielectric anisotropy. The liquid crystal molecule may be aligned so that its major axis is substantially vertical to the surfaces of the two display panels 100 and 200 in the absence of an electric field.

The first subpixel electrode 191a and the opposed electrode 270 form the first liquid crystal capacitor Clca. The second subpixel electrode 191b and the opposed electrode 270 form the second liquid crystal capacitor Clcb. The liquid crystal layer 3 is the dielectric matter for the first and second liquid crystal capacitors Clca and Clcb.

The first and second subpixel electrodes 191a and 191b with the applied data voltage together with the opposed electrode 270 of the upper panel 200 generate an electric field within the liquid crystal layer 3, which determines the direction, i.e., the inclination, of the liquid crystal module of the liquid crystal layer 3 between the two electrodes 191 and 270. The inclination direction of the liquid crystal molecules may be primarily determined by a horizontal component of the electric field that is generated by distorting the main electric field where the sides of the electrode elements (gap 91 of the pixel electrode 191, the cutout portions 92, 93a, and 93b, and the cutout portions 71, 72, 73a, 73b, 74a, and 74b of the opposed electrode 270) are substantially vertical with respect to the surfaces of the display panels 100 and 200. Therefore, the horizontal component of the electric field may be substantially vertical with respect to the sides of the gap 91 and the cutout portions 92, 93a, 93b, 71, 72, 73a, 73b, 74a, and 74b. Consequently, the liquid crystal molecules may be inclined in a direction that is substantially vertical with respect to these sides. In the exemplary embodiment, the inclinations of the liquid crystal molecules are distributed substantially in one of four directions. When the liquid crystal molecules exhibit various inclination directions, the reference viewing angle of the liquid crystal display may be large, and such an effect may be realized in the patterning of the electrodes as described in the present exemplary embodiment.

In addition, the difference between the voltage of the first and second subpixel electrodes 191a and 191b and the voltage of the opposed electrode 270 may be represented as the charge voltage of the first and second liquid crystal capacitors Clca and Clcb, that is, a pixel voltage. The alignment or inclination of the liquid crystal molecules may change depending on the magnitude of the pixel voltage that causes the electric field strength to vary. Variations in the inclination of the liquid crystal molecules may cause changes in the polarization of light incident to the liquid crystal layer 3 as the light passes through the liquid crystal layer 3. As the light polarization changes, the transmittance of the light by an exit polarizer of the display varies. Thus, the liquid crystal display displays images.

In an exemplary embodiment of the present invention, the data voltage applied to the second subpixel electrode 191b through the second switching element Qb may be changed by the third switching element Qc and the third capacitor C3 so that the charging voltage of the second liquid crystal capacitor Clcb and the first liquid crystal capacitor Clca may change, thereby altering the inclinations of the liquid crystal molecules.

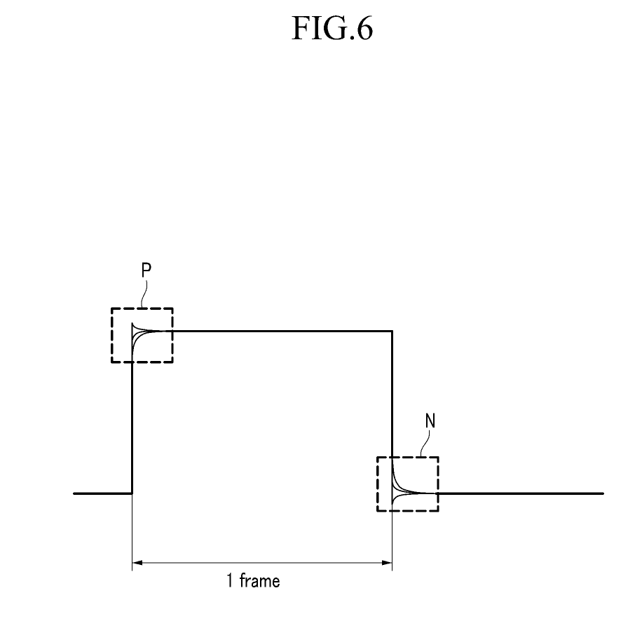

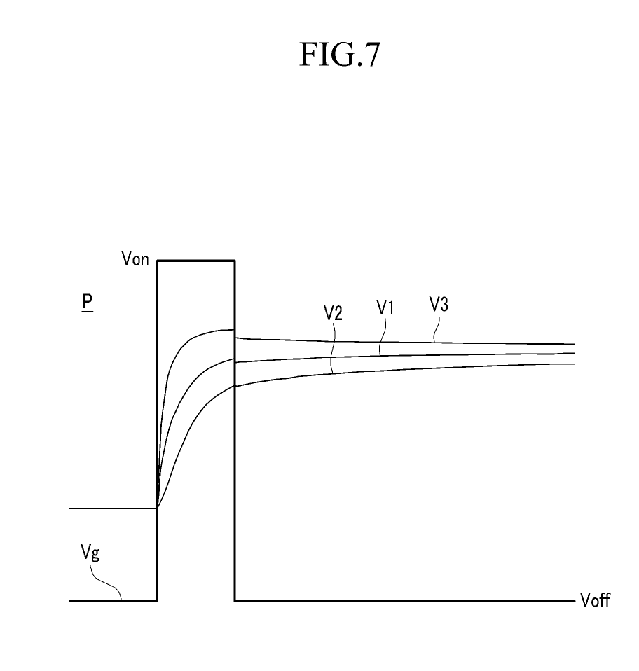

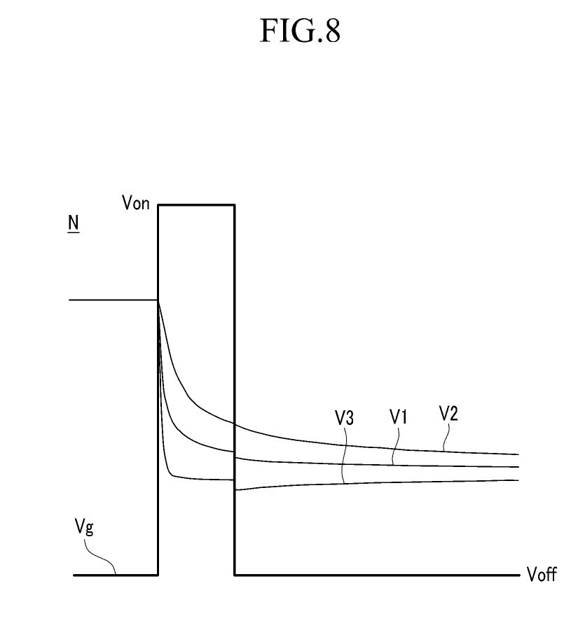

The operation of the liquid crystal display is described with reference to FIG. 1, FIG. 2, FIG. 3, and FIG. 4, FIG. 6, FIG. 7, and FIG. 8 below.

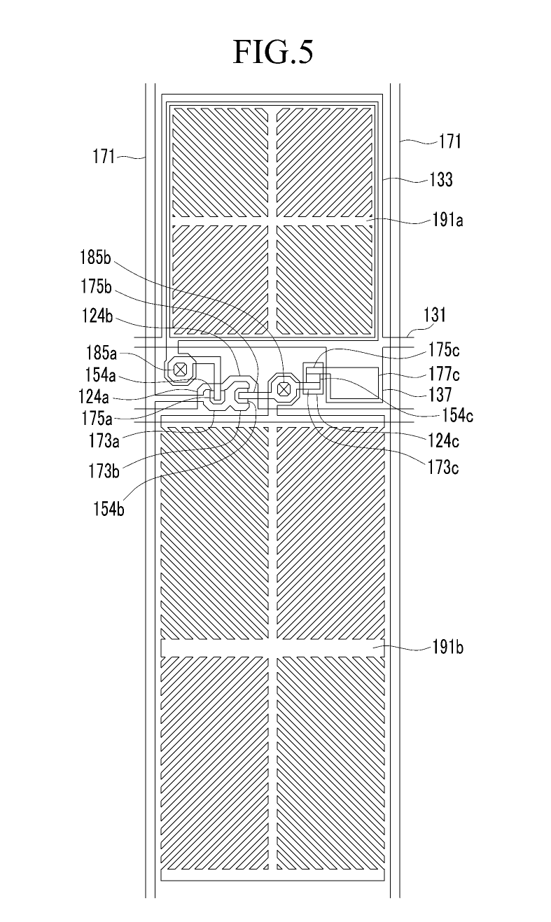

FIG. 6 is a diagram showing changes in voltages during a frame for three terminals N1, N2, and N3 of the third switching element Qc of the liquid crystal display shown in FIG. 2, FIG. 3, FIG. 4, and FIG. 5. FIG. 7 is a diagram showing an enlargement of portion “P” of FIG. 6 and a gate signal, and FIG. 8 is a diagram showing an enlargement of portion “N” of FIG. 6 and the gate signal.

The data driver 500 receives digital image signals from the an external component, selects a gray voltage corresponding to each digital image signal, converts the digital image signal into an analog data voltage Vd, and applies the analog data voltage Vd to a corresponding data line DL 171.

The gate driver 400 applies the gate-on voltage Von to the gate line GL 121 to turn-on the first and second switching elements Qa and Qb connected to the gate line GL 121. Then, the data voltage Vd applied to the data line DL 171 is applied to the first and second subpixel electrodes 191a and 191b of the corresponding pixel PX through the turned-on first and second switching elements Qa and Qb.

The process is repeated in a unit of a horizontal period. The horizontal period (as referred to as “1H”) is synonymous with one period of a horizontal synchronizing signal and a data enable signal. To display the images of one frame, the pixels PX receive the data voltage

Vd with sequential application of the gate-on voltage Von to all gate lines GL 121. When one frame is complete, the next frame starts, and a state of an inverse signal RVS applied to the data driver 500 is controlled so that the polarity of the data voltage Vd applied to each pixel PX opposes the polarity of the previous frame, i.e., so-called “frame inversion” occurs. A controller to control the state of the inversion signal RVS may be present inside or outside the data driver 500.

In the following description, the data voltage Vd is associated with positive polarity when the voltage of the opposed electrode 270 is equal to or greater than the reference voltage, and the data voltage Vd is associated with a negative polarity when the voltage of the opposed electrode 270 is less than the reference voltage.

Referring to FIG. 2, the capacitance C₁ of the first capacitor C1 occurs by the coupling of the output terminal N2 and the control terminal N1 of the third switching element Qc. The capacitance C₂ of the second capacitor C2 occurs by the coupling of the input terminal N3 and the control terminal N1, and the capacitance of the third switching element Qc is called Ctft. The voltage V1 of the control terminal N1 may be represented by Equation 1 below.

V1={(C₁+Ctft/2)*V2+(C₂+Ctft/2)*V3}/(C₁+C₂+Ctft) (Equation 1)

where V2 is the voltage at the output terminal N2, and V3 is the voltage at the input terminal N3.

According to Equation 1, when the capacitance C₁ of the first capacitor C1 is the same as the capacitance C₂, the voltage V1 of the control terminal N1 of the third switching element Qc depends on Equation 2.

V1=(V2+V3)/2 for C₁=C₂ (Equation 2)

The following description is made under the assumption that C₁ =C₂.

First, the case where the positive data voltage Vd is applied to the data line DL 171 with reference to FIG. 2, FIG. 6, and FIG. 7 is described. While the positive data voltage Vd is charged in the input terminal N3 of the third switching element Qc, the voltage V1 of the control terminal N1 has an average value of V2 and V3 so that the voltage V1 goes high. Then, in a positive frame (designated by P in FIG. 7), V1−V2 corresponding to the voltage Vgs of the third switching element Qc becomes (V3−V2)/2, which is a positive value, and current flows from the input terminal N3 to the output terminal N2. The voltage V2 of the output terminal N2 goes high. In summary, the voltage difference V1−V2 depends on Equation 3.

Vgs=V1−V2=(V3−V2)/2>0 for V3>V2 (Equation 3)

Referring to FIG. 6 and FIG. 7, after the gate signal Vg becomes the gate-off voltage Voff, current continuously flows from the input terminal N3 to the output terminal N2 until the voltage V2 of the output terminal N2, the voltage V3 of the input terminal N3, and the voltage V1 of the control terminal N1 are the same. Thus, the voltage V3 of the input terminal N3 decreases, and the voltage V2 of the output terminal N2 increases. Consequently, the voltage of the second subpixel electrode 191b connected to the input terminal N3 of the third switching element Qc is lower than the originally applied positive data voltage Vd, which is lower than the voltage of the first subpixel electrode 191a and is maintained for the remaining frame. In addition, the voltage V2 of the output terminal N2 of the third switching element Qc is also maintained for the remaining frame by the third capacitor C3.

As shown in FIG. 6, since the charging voltage of the second liquid crystal capacitor Clcb is lower than the charging voltage of the first liquid crystal capacitor Clca for most of the time of one frame, the inclination of the first crystal molecules in the first subpixel PXa and the second subpixel PXb may differ. Therefore, the luminance of the two subpixels PXa and PXb may vary as well. Hence, when the charging voltage of the first liquid crystal capacitor Clca and the charging voltage of the second liquid crystal capacitor Clcb are properly controlled, an image viewed from the side of the display maximally approximates the image viewed from the front, thereby possibly improving the side visibility of the display.

Next, the case where the negative polarity data voltage Vd is applied to the data line DL 171 is described with reference to FIG. 2, FIG. 6, and FIG. 8. While the negative polarity data voltage Vd is charged in the input terminal N3 of the third switching element Qc, the voltage V1 of the control terminal N1 goes low and attains the average value of V2 and V3. Then, in the negative frame (indicated as “N” in FIG. 8), V1−V3 corresponding to the Vgs of the third switching element Qc becomes the (V2−V3)/2, which is a positive value, and current flows from the output terminal N2 of the third switching element Qc to the input terminal N3 and the voltage V2 of the output terminal N2 decreases, as opposed to the case of the positive frame. In summary, the voltage Vgs is given by Equation 4 below.

Vgs=V1−V3=(V2−V3)/2>0 for V2≧V3

Referring to FIG. 6 and FIG. 8, after the gate signal Vg becomes the gate-off voltage Voff, current continuously flows from the input terminal N3 to the output terminal N2 until the voltage V2 of the output terminal N2, the voltage V3 of the input terminal N3, and the voltage V1 of the control terminal N1 are the same. Thus, the voltage V3 of the input terminal N3 increases, and the voltage V2 of the output terminal N2 decreases. Consequently, the voltage of the second subpixel electrode 191b connected to the input terminal N3 of the third switching element Qc is greater than the originally applied positive data voltage Vd, which is greater than the voltage of the first subpixel electrode 191a, and is maintained for the remaining time of the frame. In addition, the voltage V2 of the output terminal N2 of the third switching element Qc is also maintained for the remaining time of the frame by the third capacitor C3. In the negative frame, since the voltage difference between the second subpixel electrode 191b and the opposed electrode 270 is smaller than the voltage difference between the first subpixel electrode 191a and the opposed electrode 270, the charging voltage of the second liquid crystal capacitor Clcb is smaller than the charging voltage of the first liquid crystal capacitor Clca.

As shown in FIG. 6, since the charging voltage of the second liquid crystal capacitor Clcb is lower than the charging voltage of the first liquid crystal capacitor Clca for most of the time of one frame, the inclination of first crystal molecules in the first subpixel 191a and the second subpixel 191b may differ, and the luminance of the two subpixels 191a and 191b may also differ.

In the exemplary embodiment, after the data voltage Vd is applied, the time until the voltages V1, V2, and V3 of the terminals N1, N2, and N3 of the third switching element Qc are the same may be several tens of milliseconds (msec), more specifically, 2 msec or less. In this case, the liquid crystal display according to the exemplary embodiment of the present invention may be driven at a frequency of, e.g., 120 Hz. In this case, the voltages V1, V2, and V3 of the three terminals N1, N2, and N3 of the third switching element Qc may be equal for 50% or more of the time of one frame, more particularly, 70% or more of the time of one frame.

In addition, after the data voltage Vd is applied, the final values and the response speed where the voltages V1, V2, and V3 of the terminals N1, N2, and N3 of the third switching element Qc are equal may vary according to the capacitance and the capacitance ratio of the first capacitor C1 and the second capacitor C2. For example, when the capacitance of the second capacitor C2 is larger than the capacitance of the first capacitor C1, the final value where the three voltages V1, V2, and V3 are equal, that is, the final value of the voltage V1 of the control terminal N1, may be closer to the voltage V3 of the input terminal N3 than the voltage V2 of the output terminal N2 according to Equation 1.

In addition, the transmittance and the side distortion phenomenon of the liquid crystal display may vary according to the capacitance of the third capacitor C3. For example, when the capacitance of the third capacitor C3 is large, the transmittance may be degraded but the side distortion phenomenon may be reduced.

In addition, in the negative frame and positive frame, the time when the voltages V1, V2, and V3 of three terminals N1, N2, and N3 are equal may vary.

As described above, the luminance of the first and second subpixels PXa and PXb of the liquid crystal display according to an exemplary embodiment of the present invention may vary, thereby providing possible improvements in the visibility without reducing the aperture ratio. In addition, as shown in FIG. 6, the voltage difference between at least two terminals of the control terminal N1, the output terminal N2, and the input terminal N3 of the third switching element Qc may be substantially maintained at zero, such that the stress applied to the third switching element Qc may be substantially reduced during much of the time of one frame, e.g., 50% or more of the time of one frame, more specifically, 70% or more of the time of one frame. Consequently, display defects such as afterimages may be significantly reduced by preventing a change in the threshold voltage of the third switching element Qc, thereby possibly improving the display quality.

Another exemplary embodiment of the liquid crystal display shown in FIG. 1 and FIG. 2 will be described with reference to FIG. 5. The same components as the above exemplary embodiments are denoted by the same reference numerals so repeated descriptions may be omitted.

FIG. 5 is a layout view of one pixel of a liquid crystal display according to another exemplary embodiment of the present invention. The liquid crystal display according to the exemplary embodiment has the same cross-sectional structure as the liquid crystal display shown in FIG. 3 and FIG. 4 so corresponding reference numerals are used in FIG. 5.

The liquid crystal display according to the exemplary embodiment shown in FIG. 5 includes the lower panel 100 and the upper panel 200 facing each other and the liquid crystal layer 3 interposed between two display panels.

First describing the upper panel 200, the opposed electrode 270 may be formed on the insulation substrate 210 and the upper alignment layer (not shown) may be formed on the opposed electrode 270. The upper alignment layer may be a vertical alignment layer.

The liquid crystal layer 3 may have a negative dielectric anisotropy. When the liquid crystal molecules of the liquid crystal layer 3 are not in an electric field, the major axes of the liquid crystal molecules may be aligned vertically with respect to the surfaces of the two display panels 100 and 200.

Next, describing the lower panel 100, a plurality of gate conductors, including the plurality of gate lines 121 and the plurality of common voltage lines 131, are formed on the insulation substrate 110. The common voltage line 131 includes the downwardly extending sustain electrode 137, and a ring portion 133 extends upwardly from the sustain electrode 137 with a closed loop shape.

The gate insulating layer 140 is formed on the gate conductor, and a plurality of semiconductor stripes (not shown) including a plurality of first, second, and third semiconductors 154a, 154b, and 154c are formed on the gate insulating layer. A pair of ohmic contacts is formed on each of the first, second, and third semiconductors 154a, 154b, and 154c.

The data conductor includes the data line 171, the first drain electrode 175a, the second drain electrode 175b, and the third drain electrode 175c formed on the ohmic contacts. The data line 171 includes the first source electrode 173a and the second source electrode 173b, and a wide end portion 177c of the third drain electrode 175c forms the third capacitor C3 by overlapping with the sustain electrode 137 of the common voltage line 131.

The first/second/third gate electrodes 124a/124b/124c, the first/second/third source electrodes 173a/173b/173c, and the first/second/third drain electrodes 175a/175b/175c form the first/second/third thin film transistors Qa/Qb/Qc together with the first/ second/third semiconductors 154a/154b/154c.

The passivation layer 180 is formed on the portions of the data conductor and the exposed first, second, third semiconductors 154a, 154b, and 154c. The passivation layer 180 is formed with a first contact hole 185a exposing the wider end of the first drain electrode 175a and the second contact hole 185b exposing the wider end of the second drain electrode 175b.

The pixel electrode including the first subpixel electrode 191a and the second subpixel electrode 191b is formed on the passivation layer 180. The first subpixel electrode 191a and the second subpixel electrode 191b are separated from each other with the gate line 121 and the common voltage line 131 disposed therebetween. The first subpixel electrode 191a and the second subpixel electrode 191b are adjacently disposed up and down and in a column direction. The height of the second subpixel electrode 191b may be higher than the height of the first subpixel electrode 191a and may also be approximately 1-3 times higher than the first subpixel electrode 191a.

The first subpixel electrode 191a and the second subpixel electrode 191b may have a quadrangular shape.

The first subpixel electrode 191a includes a cross stem portion including a horizontal stem portion and a vertical stem portion, an outside portion surrounding its periphery, and a protruding portion that protrudes downward from the left lower corner of the outside portion connecting to the first drain electrode 175a through the first contact hole 185a. Meanwhile, the ring portion 133 of the common voltage line 131 surrounds the first subpixel electrode 191a, thereby possibly preventing light leakage.

The second subpixel electrode 191b includes a cross stem portion including a horizontal stem portion and a vertical stem portion, an upper horizontal portion and a lower horizontal portion, and a protruding portion that upwardly protrudes from the upper end of the vertical stem portion of the cross stem portion connecting to the second drain electrode 175b through the second contact hole 185b.

The first subpixel electrode 191a and the second subpixel electrode 191b are divided into four subregions by the cross stem portions, and the subregions include a plurality of fine branching units that obliquely extend in a direction from the cross stem portion of the subregion to the outside. The angle of the fine branching portion with respect to the gate line 121 may be approximately 45° or 135°.

The sides of the fine branching portion of the first and second subpixel electrodes 191a and 191b may distort the electric field within the liquid crystal layer 3 to form the horizontal component of the electric field to be perpendicular to the sides of the fine branching portion. The inclinations of the liquid crystal molecules are determined by the horizontal component of the electric field. Therefore, the liquid crystal molecules are inclined in a direction vertical to the sides of the fine branching portion. However, the direction of the horizontal components of the electric field oppose each other at the sides of adjacent fine branching portions, and the interval between the width of the fine branching portion or the interval of the fine branching portion may be narrow with respect to the cell gap of the liquid crystal layer 3 so that the liquid crystal molecules inclined in opposing directions may be inclined in a direction parallel to the length direction of the fine branching portion.

In the exemplary embodiment of the present invention, the first and second subpixel electrodes 191a and 191b include four subregions having different length directions of the fine branching portion so that the liquid crystal molecules are inclined into one of four directions that correspond to the four subregions. Since the liquid crystal molecules may be inclined in numerous directions, the viewing angle of the liquid crystal display may be enhanced.

Additionally, the first subpixel electrode 191a and the opposed electrode 270 form the first liquid crystal capacitor Clca, and the second subpixel electrode 191b and the opposed electrode 270 form the second liquid crystal capacitor Clcb. The liquid crystal layer 3 may be a dielectric material for the first liquid crystal capacitor Clca and the second liquid crystal capacitor Clcb.

The operation of the liquid crystal display according to the exemplary embodiment is the same as the operation of the liquid crystal display according to the exemplary embodiment of FIG. 3, FIG. 4, FIG. 6, FIG. 7, and FIG. 8. The charging voltage of the first and second liquid crystal capacitors Clca and Clcb is different so that the side visibility of the liquid crystal display may be improved. In addition, the change in the threshold voltage may be reduced by reducing the stress of the third switching element Qc. Therefore, the display quality may be improved by reducing afterimages of the liquid crystal display.

Several characteristics and effects of the liquid crystal display according to the above-mentioned exemplary embodiment shown in FIG. 3 and FIG. 4 can be applied to the liquid crystal display according to the present exemplary embodiment.

As described above, the exemplary embodiment of the present invention varies the luminance of the first and second subpixels of the liquid crystal display, thereby making it possible to improve the visibility without degrading the aperture ratio of the liquid crystal display. In addition, the present invention may reduce the stress applied to the third switching element included in the second subpixel for a certain time of one frame to prevent the change in the threshold voltage of the third switching element, thereby possibly reducing display defects such as afterimages.

While this invention has been described in connection with exemplary embodiments, it is to be understood that the invention is not limited to the exemplary embodiments. It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A liquid crystal display, comprising:
a gate line;
a data line intersecting and insulated from the gate line to supply a data voltage;
a common voltage line separated from the gate line and the data line;
a first switching element connected to the gate line and the data line;
a second switching element connected to the gate line and the data line;
a first liquid crystal capacitor connected to the first switching element;
a second liquid crystal capacitor connected to the second switching element;
a third switching element comprising an input terminal connected to the second switching element, a floated control terminal, and an output terminal; and
a third capacitor connected to the third switching element and the common voltage line.

2. The liquid crystal display of claim 1, wherein the output terminal and the control terminal of the third switching element form a first capacitor, and the input terminal and the control terminal of the third switching element form a second capacitor.

3. The liquid crystal display of claim 2, further comprising a controller to invert the polarity of the data voltage for every frame.

4. The liquid crystal display of claim 3, wherein a control terminal of the first switching element and a control terminal of the second switching element are connected to the gate line,
an input terminal of the first switching element and an input terminal of the second switching element are connected to the data line,
an output terminal of the first switching element is connected to the first liquid crystal capacitor, and
an output terminal of the second switching element is connected to the second liquid crystal capacitor and the input terminal of the third switching element.

5. The liquid crystal display of claim 1, further comprising a controller to invert the polarity of the data voltage for every frame.

6. The liquid crystal display of claim 1, wherein a control terminal of the first switching element and a control terminal of the second switching element are connected to the gate line,
an input terminal of the first switching element and an input terminal of the second switching element are connected to the data line,
an output terminal of the first switching element is connected to the first liquid crystal capacitor, and
an output terminal of the second switching element is connected to the second liquid crystal capacitor and the input terminal of the third switching element.

7. A liquid crystal display, comprising:
a first substrate and a second substrate facing each other;
a gate line, a data line to supply data voltage, and a common voltage line disposed on the first substrate;
a first switching element connected to the gate line and the data line;
a second switching element connected to the gate line and the data line;
a first subpixel electrode connected to the first switching element;
a second subpixel electrode connected to the second switching element;
a third switching element comprising an input terminal connected to the second switching element, a floated control terminal, and an output terminal facing the input terminal; and
a third capacitor comprising the output terminal of the third switching element and a portion of the common voltage line as two terminals.

8. The liquid crystal display of claim 7, wherein the output terminal and the control terminal of the third switching element form a first capacitor, and the input terminal and the control terminal of the third switching element form a second capacitor.

9. The liquid crystal display of claim 8, further comprising a controller to invert the polarity of the data voltage for every frame.

10. The liquid crystal display of claim 9, wherein a control terminal of the first switching element and a control terminal of the second switching element are connected to the gate line,
an input terminal of the first switching element and an input terminal of the second switching element are connected to the data line,
an output terminal of the first switching element is connected to the first subpixel electrode, and
an output terminal of the second switching element is connected to the second subpixel electrode and the input terminal of the third switching element.

11. The liquid crystal display of claim 10, further comprising an opposed electrode disposed on the second substrate to receive a common voltage.

12. The liquid crystal display of claim 7, further comprising a controller to invert the polarity of the data voltage for every frame.

13. The liquid crystal display of claim 7, wherein a control terminal of the first switching element and a control terminal of the second switching element are connected to the gate line,
an input terminal of the first switching element and an input terminal of the second switching element are connected to the data line,
an output terminal of the first switching element is connected to the first subpixel electrode, and
an output terminal of the second switching element is connected to the second subpixel electrode and the input terminal of the third switching element.

14. The liquid crystal display of claim 7, further comprising an opposed electrode disposed on the second substrate to receive a common voltage.

15. A driving method of a liquid crystal display comprising a gate line; a data line intersecting and insulated from the gate line; a common voltage line separated from the gate line and the data line; a first switching element connected to the gate line and the data line; a second switching element connected to the gate line and the data line; a first liquid crystal capacitor connected to the first switching element; a second liquid crystal capacitor connected to the second switching element; a third switching element comprising an input terminal connected to the second switching element, a floated control terminal, and an output terminal; and a third capacitor connected to the third switching element and the common voltage line, the method comprising:
applying a data voltage to the data line;
charging the first liquid crystal capacitor and the second liquid crystal capacitor with a first voltage by applying a gate-on voltage to the gate line; and
changing a charging voltage of the second liquid crystal capacitor through the third switching element.

16. The method of claim 15, wherein, in the third switching element, a voltage of the control terminal has a value ranging from a voltage of the input terminal to a voltage of the output terminal.

17. The method of claim 16, wherein, in the third switching element, the voltage of the control terminal, the input terminal, and the output terminal are equal for 50% of the time of one frame.

18. The method of claim 17, further comprising inverting the polarity of the data voltage for every frame.

19. The method of claim 15, wherein, in the third switching element, voltages of the control terminal, the input terminal, and the output terminal are equal for 50% of the time of one frame.

20. The method of claim 15, further comprising inverting the polarity of the data voltage for every frame.
